(19) United States
(12) Patent Application Publication
(10) Pub. No.: US 2026/0202771 A1
(43) Pub. Date: Jul. 16, 2026

(54) ELECTROPHOTOGRAPHIC PHOTOSENSITIVE MEMBER, PROCESS CARTRIDGE, AND IMAGE FORMING APPARATUS

(71) Applicant: KYOCERA DOCUMENT SOLUTIONS INC., OSAKA (JP)

(72) Inventors: TERUYUKI UEMURA, OSAKA (JP); TOMOFUMI SHIMIZU, OSAKA (JP); MAKOTO SHISHIDO, OSAKA (JP); KATSUNORI TERAOKA, OSAKA (JP); KEIJI OZAWA, OSAKA (JP)

(21) Appl. No.: 19/449,345

(22) Filed: Jan. 14, 2026

(30) Foreign Application Priority Data
Jan. 16, 2025 (JP) 2025-006025

(51) Int. Cl. G03G 5/10; G03G 5/06; G03G 15/04; G03G 21/18

(52) U.S. Cl. CPC G03G 5/105; G03G 5/06147; G03G 5/0696; G03G 15/04; G03G 21/18

(57) ABSTRACT

There is provided an electrophotographic photosensitive member, a process cartridge, and an image forming apparatus with superior electrical characteristics. The electrophotographic photosensitive member includes a conductive base and a photosensitive layer. The photosensitive layer is provided on the conductive base. The photosensitive layer contains a base material, a charge generation material, a dispersing aid, a hole transport agent, and an electron transport agent. The base material is a polyarylate resin having repeating units represented by the following formula (1), formula (2), formula (3), and formula (4), in which a content ratio of the repeating units represented by the formula (3) with respect to a total number of the repeating units represented by the formula (1) and formula (3) is greater than 0% and less than 20%. The charge generation material is titanyl phthalocyanine. The dispersion aid includes a compound represented by the following formula (5) or formula (6). The hole transport agent includes a compound represented by the following formula (7) or formula (8).

### CROSS-REFERENCE TO RELATED PATENT APPLICATION

This application claims the benefit of Japanese Priority Patent Application JP 2025-006025 filed on Jan. 16, 2025, the entire contents of which are incorporated herein by reference.

### FIELD OF THE DISCLOSURE

The present disclosure relates to an electrophotographic photosensitive member, a process cartridge, and an image forming apparatus used in electrophotographic printing.

### BACKGROUND OF THE DISCLOSURE

An electrophotographic photosensitive member is used as an image carrier in an image forming apparatus used in electrophotographic printing such as a printer. The electrophotographic photosensitive member includes a photosensitive layer laminated on a conductive base, and the photosensitive layer has a structure having a thermoplastic binder resin into which functional materials are dispersed. A surface of the photosensitive member is used in a state of positively or negatively charged in advance. When the surface of the photosensitive member is exposed, charges in an exposed area decay. When toner charged with the same polarity as the surface is supplied to the surface of the photosensitive member, the toner adheres only to the exposed area, forming a toner image. This toner image is transferred to a printing target, such as printing paper, to perform printing.

In the image forming apparatus used in the electrophotographic printing, printing is performed as described above by controlling the charges on the surface of the photosensitive member. Therefore, electrical characteristics of the electrophotographic photosensitive member are important for printing performance.

### SUMMARY OF THE DISCLOSURE

To achieve the above object, an electrophotographic photosensitive member according to an embodiment of the present disclosure includes a conductive base and a photosensitive layer.

The photosensitive layer is provided on the conductive base.

The photosensitive layer contains a base material, a charge generation material, a dispersing aid, a hole transport agent, and an electron transport agent. The base material is a polyarylate resin having repeating units represented by the following formula (1), formula (2), formula (3), and formula (4), in which a content ratio of the repeating units represented by the formula (3) with respect to a total number of the repeating units represented by the formula (1) and formula (3) is greater than 0% and less than 20%.

The charge generation material is titanyl phthalocyanine.

The dispersion aid includes a compound represented by the following formula (5) or formula (6).

The hole transport agent includes a compound represented by the following formula (7) or formula (8).

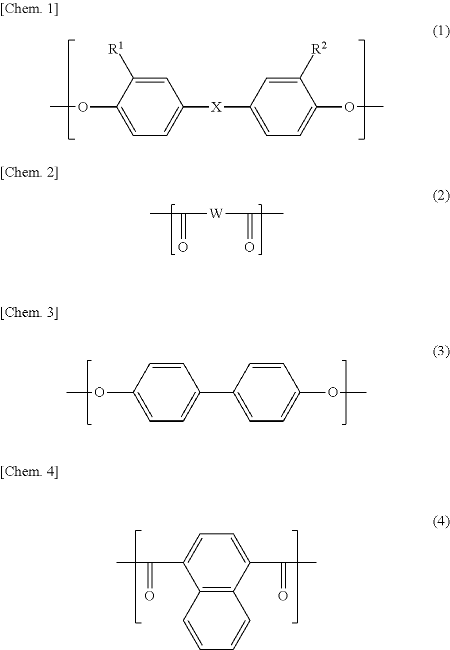

In the formula (1), R¹ and R² each independently represents a hydrogen atom or a methyl group, and X represents a divalent group represented by the following formula (X1) or formula (X2), in the formula (2), W represents a divalent group represented by the following formula (W1) or formula (W2).

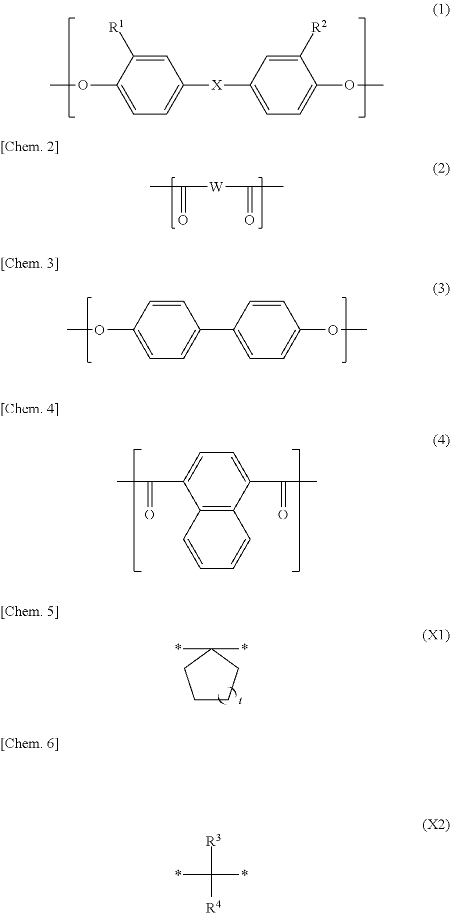

In the formula (X1), t represents an integer of 1 or more and 3 or less, * represents a bond, in the formula (X2), R³ and R⁴ each represents a hydrogen atom or an alkyl group having 1 or more and 4 or less carbon atoms, which are mutually different groups, * represents a bond.

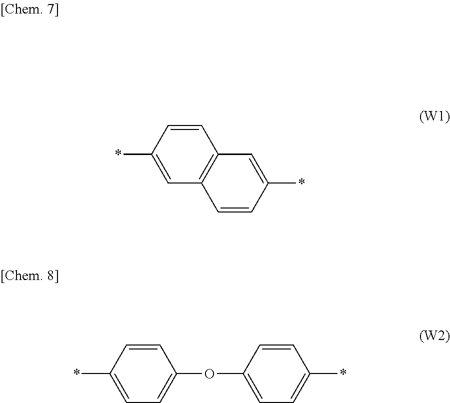 [SMILES: *c1ccc2cc(*)ccc2c1 ; *c1ccc(Oc2ccc(*)cc2)cc1]

In the formula (W1) and the formula (W2), * represents a bond.

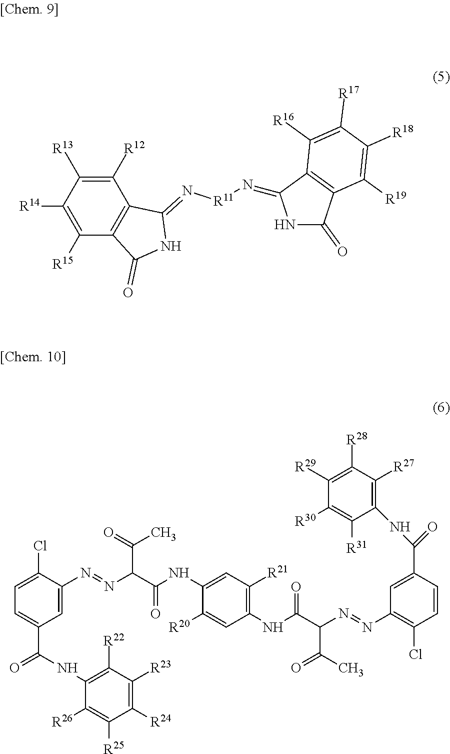

(In the formula (5), R¹¹ represents a phenylene group which may be substituted by an alkyl group, or a biphenyldiyl group which may be substituted by an alkyl group, R¹², R¹³, R¹⁴, R¹⁵, R¹⁶, R¹⁷, R¹⁸, and R¹⁹ each independently represents a hydrogen atom or a halogen atom, and in the formula (6), R²⁰ and R²¹ each independently represents a hydrogen atom or a halogen atom, and R²², R²³, R²⁴, R²⁵, R²⁶, R²⁷, R²⁸, R²⁹, R³⁰, and R³¹ each independently represents a hydrogen atom, a halogen atom, a trifluoromethyl group, or a phenoxy group.)

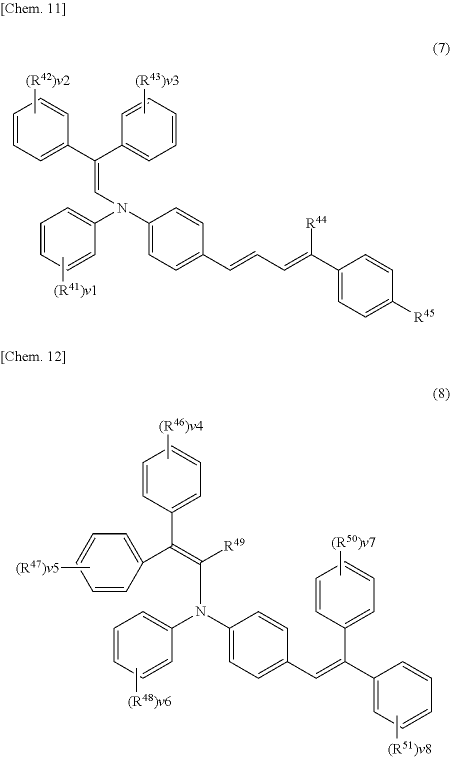

(In the formula (7) and the formula (8), R⁴¹ represents an alkyl group having 1 to 8 carbon atoms or an alkoxy group having 1 to 8 carbon atoms, R⁴², R⁴³, R⁴⁶, R⁴⁷, R⁴⁸, R⁵⁰, and R⁵¹ each independently represents an alkyl group having 1 to 8 carbon atoms, R⁴⁴ represents an aryl group or a hydrogen atom, R⁴⁵ and R⁴⁹ each represents an alkyl group having 1 to 8 carbon atoms or a hydrogen atom, and v1, v2, v3, v4, v5, v6, v7, and v8 each independently represents an integer of 0 to 5.)

The electron transport agent may be a compound represented by the following formula (9), formula (10), formula (11), formula (12), formula (13), formula (14), or formula (15).

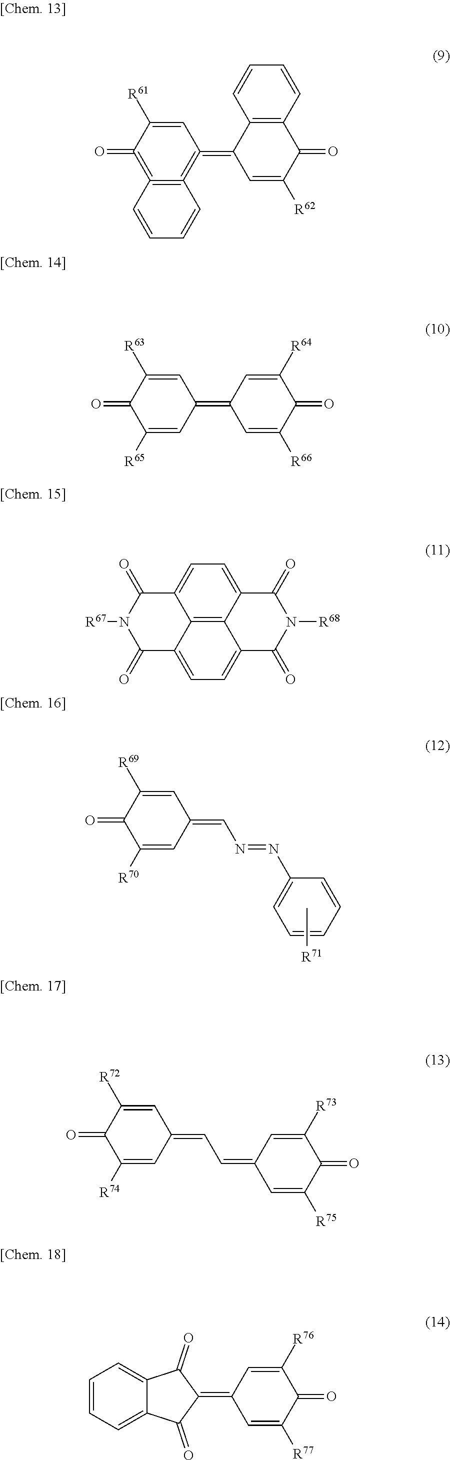

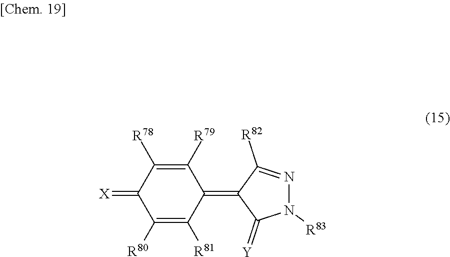

(In the formula (9), the formula (10), the formula (11), the formula (12), the formula (13), the formula (14), and the formula (15), R⁶¹, R⁶², R⁶³, R⁶⁴, R⁶⁵, R⁶⁶, R⁶⁷, R⁶⁸, R⁶⁹, R⁷⁰, R⁷¹, R⁷², R⁷³, R⁷⁴, R⁷⁵, R⁷⁶, R⁷⁷, R⁷⁸, R⁷⁹, R⁸⁰, R⁸¹, R⁸², and R⁸³ are each independently represents a hydrogen atom, a halogen atom, a cyano group, an alkyl group having 1 to 6 carbon atoms, an alkenyl group having 2 to 6 carbon atoms, an alkoxy group having 1 to 6 carbon atoms, an allyl group having 6 to 14 carbon atoms which may have at least one alkyl group having 1 to 6 carbon atoms, or a halogenated aryl group having 6 to 14 carbon atoms which may have at least one alkyl group having 1 to 6 carbon atoms.)

To achieve the above object, a process cartridge according to an embodiment of the present disclosure includes the electrophotographic photosensitive member.

To achieve the above object, an image forming apparatus according to an embodiment of the present disclosure includes an electrophotographic photosensitive member, a charging device, an exposure device, a developing device, and a transfer device.

The electrophotographic photosensitive member has the configuration described above.

The charging device charges a surface of the electrophotographic photosensitive member.

The exposure device exposes the charged surface to form an electrostatic latent image on the surface.

The developing device develops the electrostatic latent image into a toner image.

The transfer device transfers the toner image from the electrophotographic photosensitive member to a transfer target.

The charging device may include a charging roller.

The developing device may be a two-component developing system.

### BRIEF DESCRIPTION OF THE DRAWINGS

FIG. 1 is a schematic diagram of an electrophotographic photosensitive member according to an embodiment of the present disclosure.

FIG. 2 is a schematic diagram showing a configuration of an image forming apparatus according to an embodiment of the present disclosure.

FIG. 3 is a schematic diagram showing the configuration of an image forming unit provided in the image forming apparatus.

### DETAILED DESCRIPTION OF THE EXEMPLARY EMBODIMENTS

An electrophotographic photosensitive member according to the present disclosure will be described.

### <Configuration of Electrophotographic Photosensitive Member>

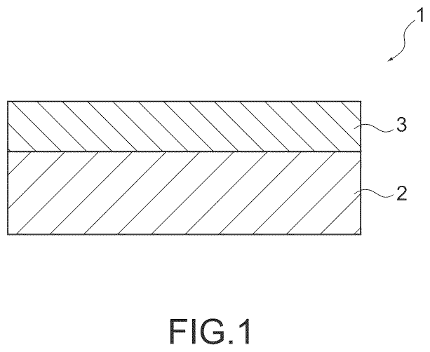

FIG. 1 is a schematic diagram of an electrophotographic photosensitive member 1 according to an embodiment of the present disclosure. As shown in FIG. 1, the electrophotographic photosensitive member 1 includes a conductive base 2 and a photosensitive layer 3. The conductive base 2 is a cylindrical or tubular member made of a conductive material such as a metal. The photosensitive layer 3 is provided on the conductive base 2. The electrophotographic photosensitive member 1 is a single-layered electrophotographic photosensitive member having a single photosensitive layer 3.

### [Configuration of Photosensitive Layer]

The photosensitive layer 3 generates electrons through light absorption and transports the generated electrons to a surface of the electrophotographic photosensitive member 1 (hereinafter referred to as photosensitive member surface). The photosensitive layer 3 contains a base material, a charge generation material, a dispersing aid, a hole transport agent, and an electron transport agent, and has a configuration where the charge generation material, the dispersing aid, the hole transport agent, and the electron transport agent are dispersed within the base material. A thickness of the photosensitive layer 3 is not particularly limited, but 5 μm or more and 100 μm or less is preferred.

### (Base Material)

The base material is a polyarylate resin having repeating units represented by the following formula (1), formula (2), formula (3), and formula (4), in which a content ratio of the repeating unit represented by formula (3) with respect to a total number of the repeating units represented by formula (1) and formula (3) is greater than 0% and less than 20%.

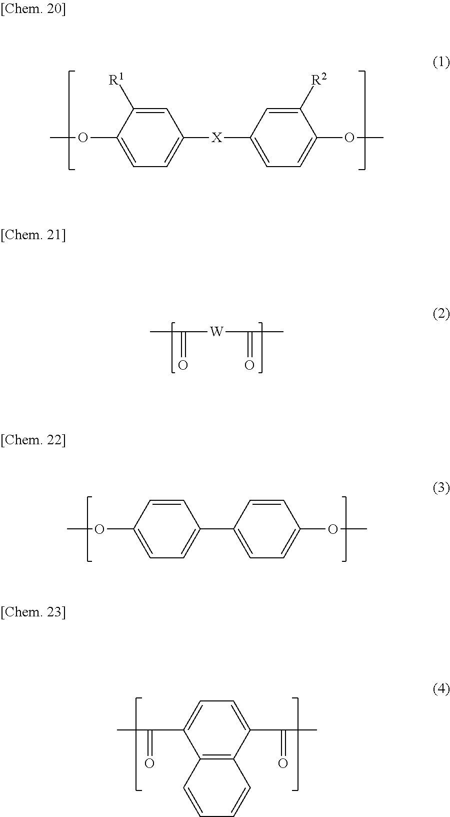

In the formula (1), R¹ and R² each independently represents a hydrogen atom or a methyl group, and X represents a divalent group represented by the following formula (X1) or formula (X2). In formula (2), W represents a divalent group represented by the following formula (W1) or formula (W2).

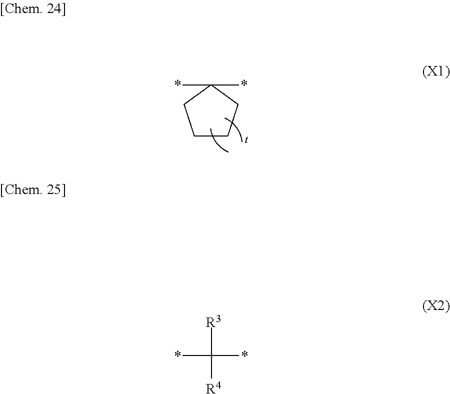

In the formula (X1), t represents an integer of 1 or more and 3 or less, and * represents a bond. In the formula (X2), R³ and R⁴ each represents a hydrogen atom or an alkyl group having 1 or more and 4 or less carbon atoms, which are mutually different groups, and * represents a bond.

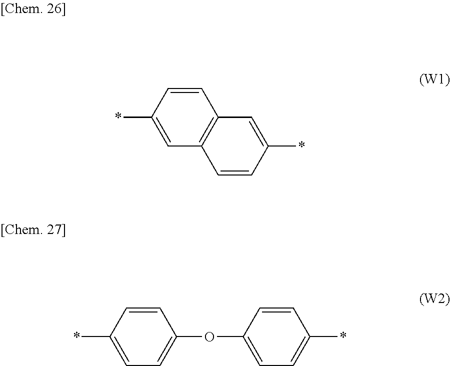 [SMILES: *c1ccc2cc(*)ccc2c1 ; *c1ccc(Oc2ccc(*)cc2)cc1]

In the formula (W1) and the formula (W2), * denotes a binding hand.

Specifically, as the repeating unit of formula (1), one or more types of repeating units of the following formula (1-1), formula (1-2), and formula (1-3) can be used.

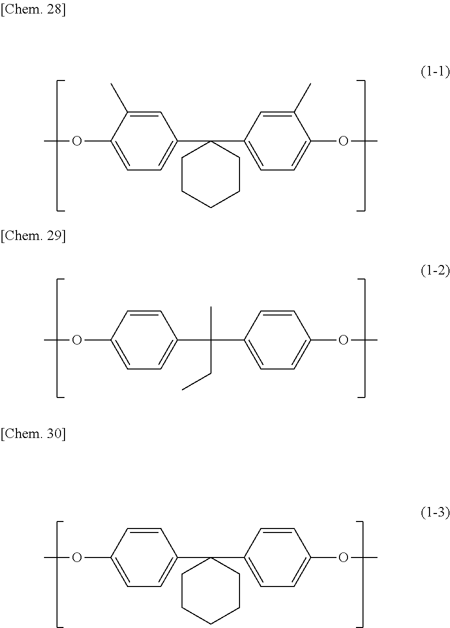

Furthermore, either or both of the following repeating units (2-1) and (2-2) can be used as the repeating unit of the formula (2).

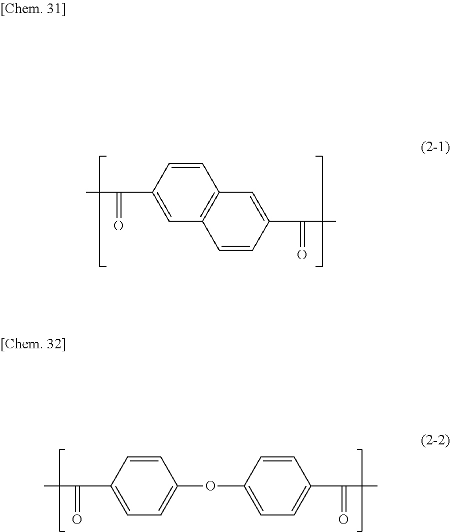

The polyarylate resin can be produced by condensation polymerization of bisphenol and dicarboxylic acid. Among the repeating units represented by the formula (1), the formula (2), the formula (3), and the formula (4), the repeating units represented by the formula (1) and the formula (3) are repeating units derived from bisphenol, and the repeating units represented by the formula (2) and the formula (4) are repeating units derived from dicarboxylic acid.

Specifically, the repeating unit of the formula (1-1) is derived from bisphenol CZ shown in the following formula (1-1a), and the repeating unit of the formula (1-2) is derived from bisphenol B shown in the following formula (1-2a). The repeating unit of the formula (1-3) is derived from bisphenol Z shown in the following formula (1-3a). Furthermore, the repeating unit of the formula (3) is derived from BP shown in the following formula (3a).

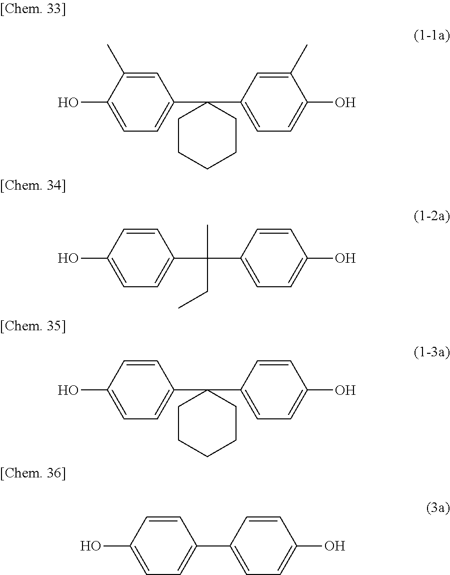

Furthermore, the repeating unit of the formula (2-1) is a derived from 26NACC (2,6-Naphthalenedicarboxylic Acid) represented by the following formula (2-1a). The repeating unit of the formula (2-2) is derived from DCDE (Dicarboxydiphenyl Ether) represented by the following formula (2-2a). The repeating unit of the formula (4) is derived from 14NACC (1,4-Naphthalenedicarboxylic Acid) represented by the following formula (4a).

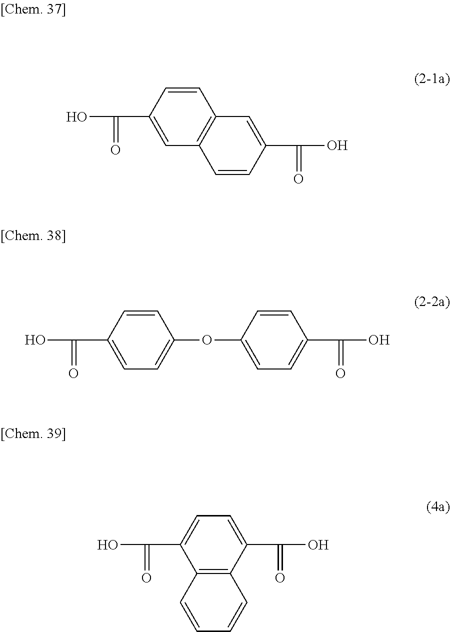

In the polyarylate resin, the repeating units derived from bisphenol (formula (1) and formula (3)) and the repeating units derived from dicarboxylic acid (formula (2) and formula (4)) are bonded to each other in adjacent positions. The repeating unit of the formula (1) may be bonded to the repeating unit of the formula (2) or to the repeating unit of the formula (4). The repeating unit of formula (3) may be bonded to the repeating unit of formula (2) or to the repeating unit of the formula (4). The polyarylate resin may be a random copolymer, an alternating copolymer, a cyclic copolymer, or a block copolymer.

A content ratio (molar fraction, the same applies hereinafter for content ratio) of bisphenol and dicarboxylic acid in the polyarylate resin is preferably equal. Among these, for bisphenol, a content ratio of the repeating unit represented by formula (1) to a total number of the repeating units represented by formula (1) and the formula (3) is preferably 81% or more and 95% or less. Furthermore, a content ratio of the repeating unit represented by formula (3) with respect to the total number of repeating units represented by formula (1) and formula (3) is preferably greater than 0% and less than or equal to 20%, and more preferably 5% or more and less than or equal to 19%.

Furthermore, for dicarboxylic acid, a content ratio of the repeating units represented by the formula (2) with respect to a total number of repeating units represented by the formula (2) and the formula (4) is preferably 35% or more and 65% or less. A content ratio of the repeating unit represented by the formula (4) with respect to the total number of repeating units represented by the formula (2) and the formula (4) is also preferably 35% or more and 65% or less.

The content ratio of each repeating unit in the polyarylate resin can be calculated by measuring a 1H-NMR (Nuclear Magnetic Resonance) spectrum of the polyarylate resin using a proton NMR spectrometer from a ratio of peaks characteristic of each repeating unit in the 1H-NMR spectrum.

The polyarate resin may have terminal groups. The terminal groups may be groups derived from DMP (Dimethylphenol) represented by the following formula (M-1) or groups derived from PFH (Perfluoroheptanol) represented by a formula (M-2).

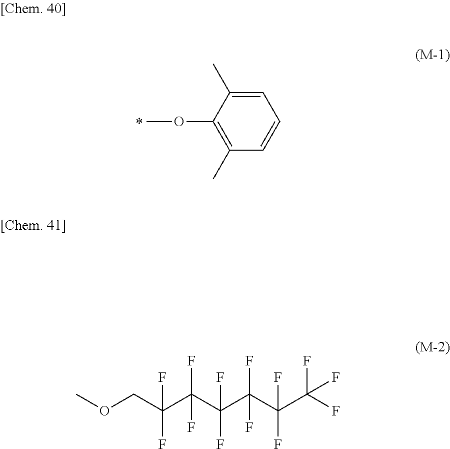

### (Charge Generation Material)

The charge generation material is titanyl phthalocyanine represented by the following formula (CG-1).

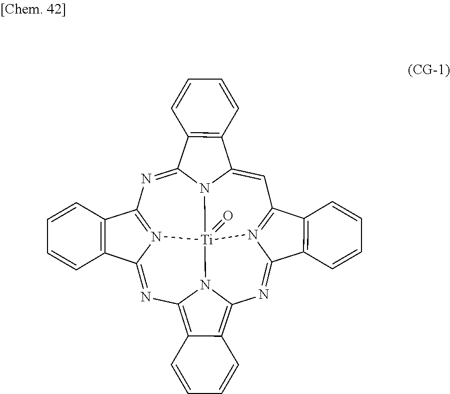

A content of the charge-generating agent is preferably 0.1 mass part or more and 50 mass parts or less, and more preferably 0.5 mass part or more and 5 mass parts or less with respect to 100 mass parts of the base material.

### (Dispersing Aid)

The dispersing aid includes a compound represented by the following formula (5) or formula (6).

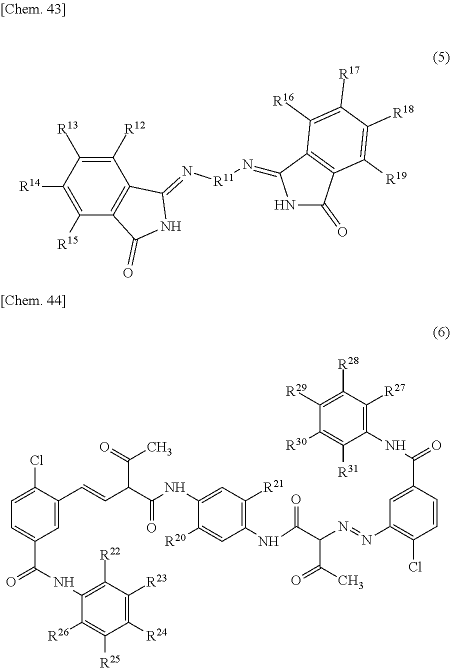

In the formula (5), R¹¹ represents a phenylene group which may be substituted by an alkyl group, or a biphenyldiyl group which may be substituted by an alkyl group, R¹¹, R¹², R¹³, R¹⁴, R¹⁵, R¹⁶, R¹⁷, R¹⁸, and R¹⁹ each independently represents a halogen atom. Herein, “a phenylene group which may be substituted by an alkyl group” means a phenylene group or a phenylene group substituted by one or more alkyl groups. Furthermore, “a biphenyldiyl group which may be substituted by an alkyl group” means a biphenyldiyl group or a biphenyldiyl group substituted by one or more alkyl groups. In the formula (6), R²⁰, R²¹, R²², R²³, R²⁴, R²5, R²⁶, R²⁷, R²⁸, R²⁹, R³⁰, and R³¹ each independently represents a hydrogen atom, a halogen atom, a trifluoromethyl group, or a phenoxy group.

Specifically, as the compounds shown in the formula (5), a compound represented by the following formula (P-1) can be used.

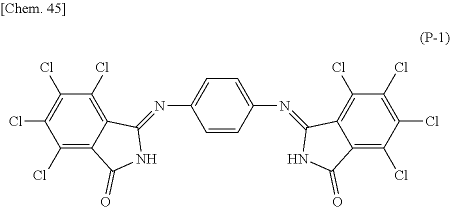 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21]

Furthermore, as the compound represented by the formula (6), compounds represented by the following formula (P-2) and formula (P-3) may be used.

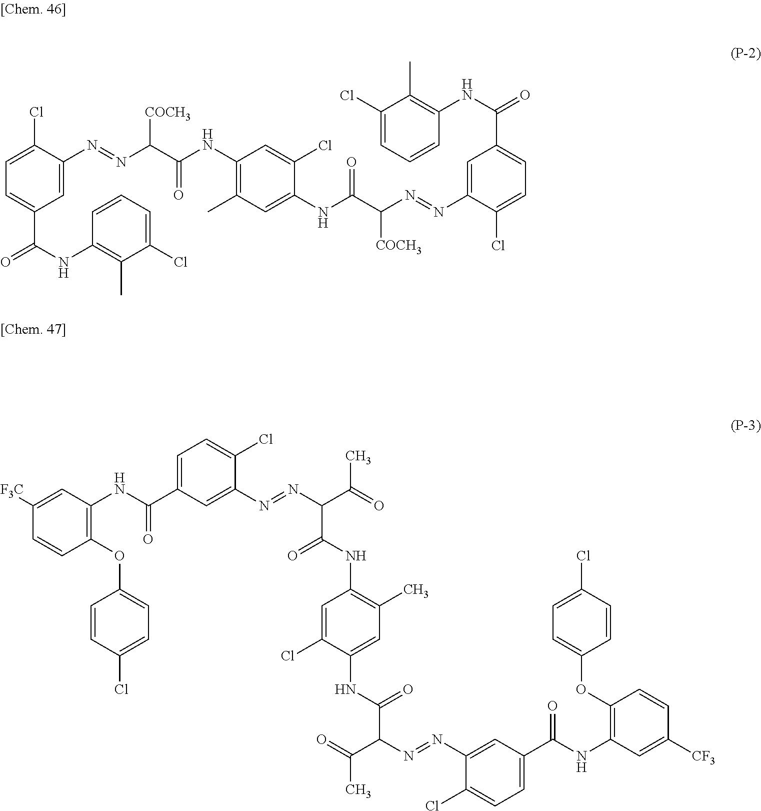 [SMILES: CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C ; CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C]

A content of the dispersing aid is preferably 0.1 mass part or more and 50 mass parts or less, and more preferably 0.5 mass part or more and 5 mass parts or less with respect to 100 mass parts of the base material.

### (Hole Transport Agent)

The hole transport agent includes compounds represented by the following formula (7) or formula (8).

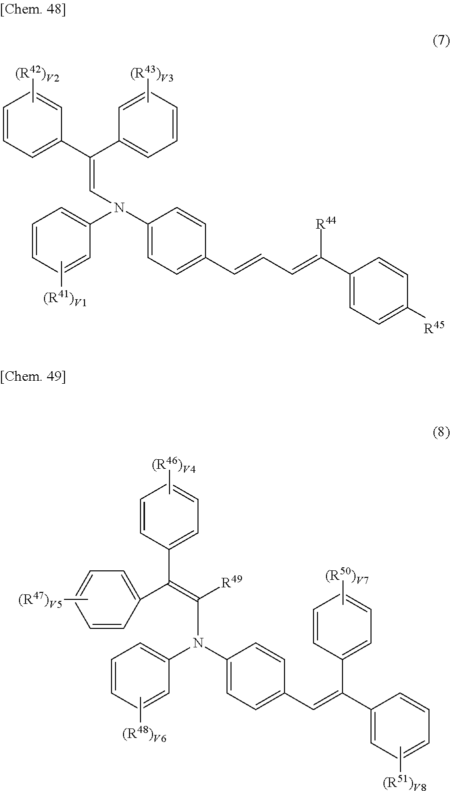

In the formula (7) and the formula (8), R⁴¹ represents an alkyl group having 1 to 8 carbon atoms or an alkoxy group having 1 to 8 carbon atoms, and R⁴², R⁴³, R⁴⁶, R⁴⁷, R⁴⁸, R⁵⁰, and R⁵¹ each independently represents an alkyl group having 1 to 8 carbon atoms, R⁴⁴ represents an aryl group or a hydrogen atom, R⁴⁵ and R⁴⁹ each represents an alkyl group having 1 to 8 carbon atoms or a hydrogen atom, and v1, v2, v3, v4, v5, v6, v7, and v8 each independently represents an integer of 0 to 5.

Specifically, as the compound represented by the formula (7), compounds represented by the following formula (H-1), formula (H-2), formula (H-4), or formula (H-5) can be used.

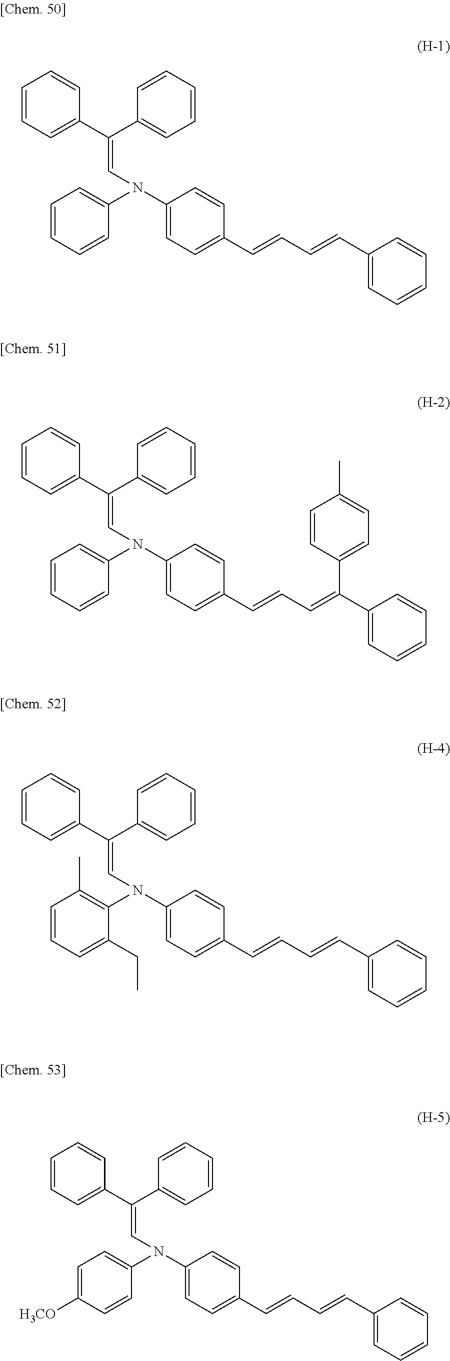 [SMILES: C(=C(c1ccccc1)c1ccccc1)N(c1ccccc1)c1ccc(/C=C/C=C/c2ccccc2)cc1 ; Cc1ccc(/C(=C\C=C\c2ccc(N(C=C(c3ccccc3)c3ccccc3)c3ccccc3)cc2)c2ccccc2)cc1 ; CCc1cccc(C)c1N(C=C(c1ccccc1)c1ccccc1)c1ccc(/C=C/C=C/c2ccccc2)cc1 ; COc1ccc(N(C=C(c2ccccc2)c2ccccc2)c2ccc(/C=C/C=C/c3ccccc3)cc2)cc1]

Furthermore, as the compound represented by the formula (8), a compound represented by the following formula (H-3) can be used.

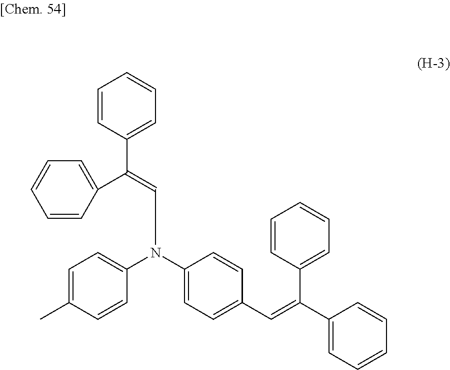 [SMILES: Cc1ccc(N(C=C(c2ccccc2)c2ccccc2)c2ccc(C=C(c3ccccc3)c3ccccc3)cc2)cc1]

A content of the hole transport agent is preferably 0.1 mass part or more and 50 mass parts or less, and more preferably 0.5 mass part or more and 5 mass parts or less with respect to 100 mass parts of the substrate.

### (Electron Transport Agent)

Examples of the electron transport agent include a quinone compound, a diimide compound, a hydrazone compound, a malononitrile-based compound, a thiopyran-based compound, a trinitrothioxanthon-based compound, 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacridine, succinic anhydride, maleic anhydride, and dibromo maleic anhydride. Examples of the quinone-based compound include a diphenoxyquinone-based compound, an azoquinone-based compound, an anthraquinone-based compound, a naphthoquinone-based compound, a nitroanthraquinone-based compounds, and a dinitroanthraquinone-based compound. The photosensitive layer 3 may contain only one type of electron transport agent or may contain two or more types of electron transport agents.

Specifically, as the electron transport agent, compounds represented by the following formula (9), formula (10), formula (11), formula (12), formula (13), formula (14), or formula (15) can be used.

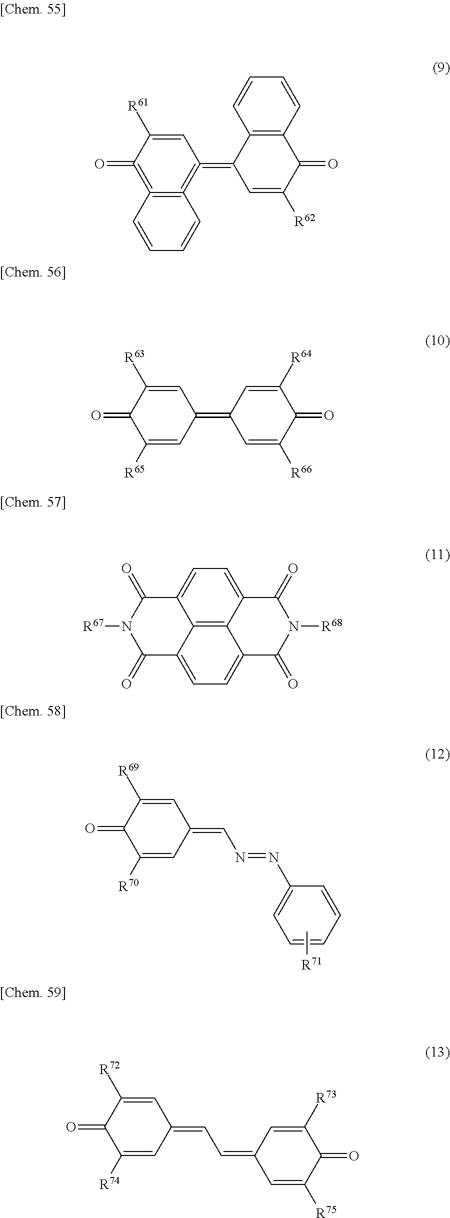

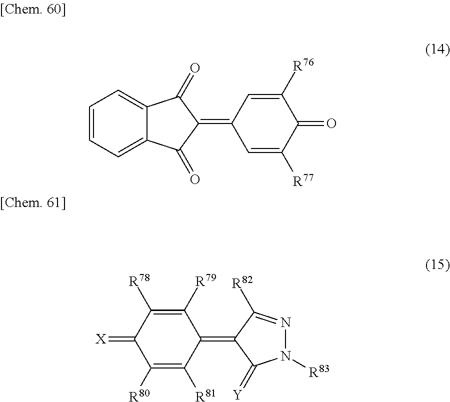

In the formula (9), the formula (10), the formula (11), the formula (12), the formula (13), the formula (14), and the formula (15), R⁶¹, R⁶², R⁶³, R⁶⁴, R⁶⁵, R⁶⁶, R⁶⁷, R⁶⁸, R⁶⁹, R⁷⁰, R⁷¹, R⁷², R⁷³, R⁷⁴, R⁷⁵, R⁷⁶, R⁷⁷, R⁷⁸, R⁷⁹, R⁸⁰, R⁸¹, R⁸², and R⁸³ are each independently represents a hydrogen atom, a halogen atom, a cyano group, an alkyl group having 1 to 6 carbon atoms, an alkenyl group having 2 to 6 carbon atoms, an alkoxy group having 1 to 6 carbon atoms, an allyl group having 6 to 14 carbon atoms which may have at least one alkyl group having 1 to 6 carbon atoms, or a halogenated aryl group having 6 to 14 carbon atoms which may have at least one alkyl group having 1 to 6 carbon atoms. Furthermore, “an allyl group having 6 to 14 carbon atoms which may have at least one alkyl group having 1 to 6 carbon atoms” means an allyl group having 6 to 14 carbon atoms or an allyl group having 6 to 14 carbon atoms substituted by one or more alkyl groups having 1 to 6 carbon atoms. Furthermore, “a halogenated aryl group having 6 to 14 carbon atoms which may optionally have at least one alkyl group having 1 to 6 carbon atoms” means a halogenated aryl group having 6 to 14 carbon atoms or a halogenated aryl group having 6 to 14 carbon atoms substituted by one or more alkyl groups having 1 to 6 carbon atoms.

Specifically, as the compound represented by the formula (9), a compound represented by the following formula (E-1) can be used.

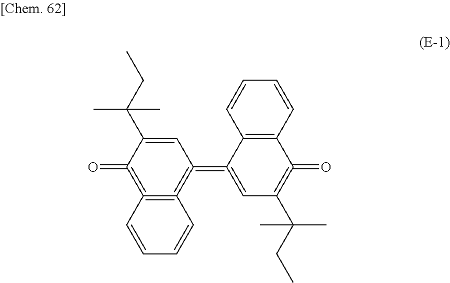

Furthermore, as the compound represented by the formula (10), a compound represented by the following formula (E-7) can be used.

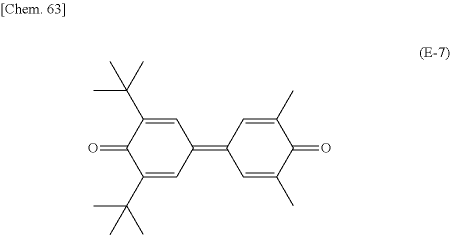 [SMILES: CC1=CC(=C2C=C(C(C)(C)C)C(=O)C(C(C)(C)C)=C2)C=C(C)C1=O]

Furthermore, as the compound represented by the formula (11), a compound represented by the following formula (E-6) can be used.

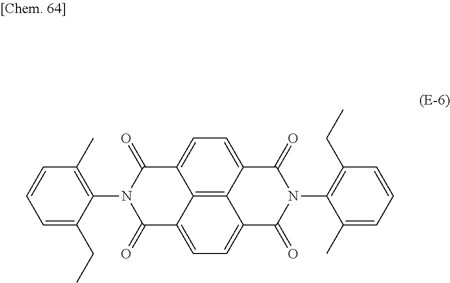 [SMILES: CCc1cccc(C)c1N1C(=O)c2ccc3c4c(ccc(c24)C1=O)C(=O)N(c1c(C)cccc1CC)C3=O]

Furthermore, as the compound represented by the (12), compounds represented by the following formula (E-5) can be used.

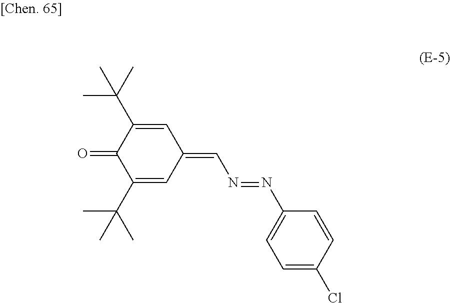 [SMILES: CC(C)(C)C1=CC(=C/N=N/c2ccc(Cl)cc2)C=C(C(C)(C)C)C1=O]

Furthermore, as the compound represented by the (13), a compound represented by the following formula (E-8) can be used.

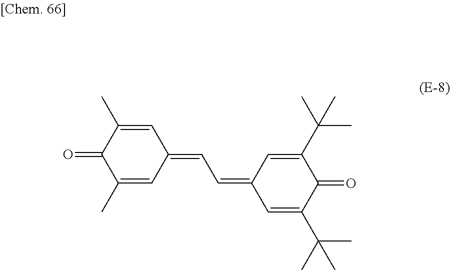 [SMILES: CC1=CC(=CC=C2C=C(C(C)(C)C)C(=O)C(C(C)(C)C)=C2)C=C(C)C1=O]

Furthermore, as the compound represented by the (14), a compound represented by the following formula (E-3) can be used.

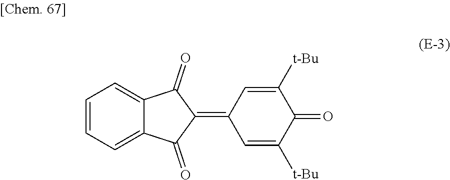 [SMILES: CC(C)(C)C1=CC(=C2C(=O)c3ccccc3C2=O)C=C(C(C)(C)C)C1=O]

Furthermore, as the compound represented by the (15), a compound represented by formula (E-2) or formula (E-4) can be used.

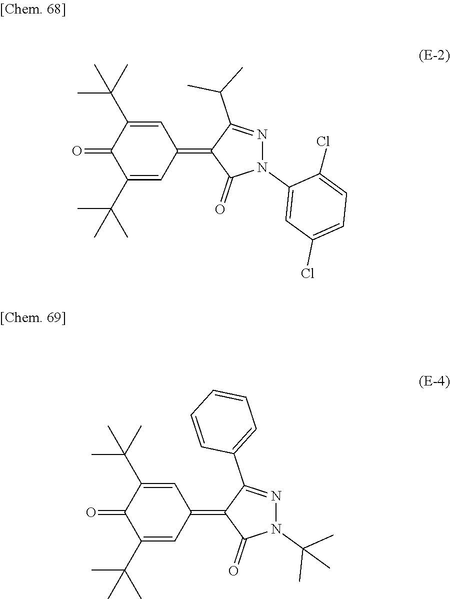 [SMILES: CC(C)C1=NN(c2cc(Cl)ccc2Cl)C(=O)C1=C1C=C(C(C)(C)C)C(=O)C(C(C)(C)C)=C1 ; CC(C)(C)C1=CC(=C2C(=O)N(C(C)(C)C)N=C2c2ccccc2)C=C(C(C)(C)C)C1=O]

A content of the electron transport agent contained is preferably 0.1 mass part or more and 50 mass parts or less, and more preferably 0.5 mass part or more and 5 mass parts or less with respect to 100 mass parts of the base material.

The photosensitive layer 3 has the above configuration. The photosensitive layer 3 may also contain an additive in addition to the materials described above. Examples of the additive include an ultraviolet absorber, an antioxidant, a radical scavenger, a singlet quencher, a plasticizer, a surface modifier, a bulking agent, a thickener, a dispersion stabilizer, wax, a donor, a surfactant, a plasticizer, a sensitizer, and a leveling agent. The photosensitive layer 3 may contain one type or two or more types of these additives.

The electrophotographic photosensitive member 1 may include at least the photosensitive layer 3 and may further comprise other layer. For example, the electrophotographic photosensitive member 1 may include an undercoat layer disposed between the conductive base 2 and the photosensitive layer 3, or a protective layer covering the photosensitive layer 3.

### <Method for Manufacturing Photosensitive Member>

As a method for manufacturing the electrophotographic photosensitive member 1, a method for manufacturing the base material will first be described. The base material is a polyarylate resin as described above, and can be produced by condensation polymerization of bisphenol and dicarboxylic acid. Any known polymerization methods such as solution polymerization, melt polymerization, or interfacial polymerization can be used for the condensation polymerization.

At this time, amounts (molar fractions) of bisphenol and dicarboxylic acid can be equal. Furthermore, the amount in the bisphenol is such that the content ratio of the repeating unit represented by formula (3) in the polyarylate resin produced is greater than 0% and less than or equal to 20% with respect to the total number of the repeating units represented by the formula (1) and the formula (3) described above.

Specifically, as the bisphenol, any one or more of bisphenol CZ represented by in the formula (1-la), bisphenol B represented by the formula (1-2a), and bisphenol Z represented by the formula (1-3a) are used in combination with BP represented by the formula (3a). Therefore, the amount (molar fraction) of the BP is greater than 0% and less than or equal to 20% with respect to a total amount of the bisphenol CZ, the bisphenol B, and the bisphenol Z.

In addition, the dicarboxylic acid is 26NACC represented by the formula (2-la) or DCDE represented by the formula (2-2a) and 14NACC represented by the formula (4a). By mixing these dicarboxylic acids with the bisphenol adjusted as described above and causing the condensation polymerization, a polyarylate resin can be produced in which the content ratio of the repeating unit represented by the formula (3) with respect to the total number of repeating units represented by the formula (1) and the formula (3) is greater than 0% and less than or equal to 20%.

The bisphenol and dicarboxylic acid may be derived. A terminal stopping agent may also be added in the condensation polymerization. DMP or PFH, etc., may be used as the terminal stopping agent.

Next, the manufacturing method for the electrophotographic photosensitive member 1 using the aforementioned polyarate resin will be described. The electrophotographic photosensitive member 1 can be manufactured by laminating the photosensitive layer 3 on the conductive base 2 (see FIG. 1). The photosensitive layer 3 can be formed on the conductive base 2 by preparing a coating solution including the base material made from the aforementioned polyarylate resin, the charge generation material, the dispersion aid, the hole transport agent, and the electron transport agent mixed with a solvent, coating this coating solution to the conductive base 2, and removing the solvent. Mixing of the materials can be performed using, for example, a bead mill, a roll mill, a ball mill, an attritor, a paint shaker, a rod-type ultrasonic transducer, or an ultrasonic disperser.

The solvent may be any that can dissolve the polyarylate resin, such as alcohols (specifically, methanol, ethanol, isopropanol, and butanol, etc.), aliphatic hydrocarbons (specifically, n-hexane, octane, and cyclohexane, etc.), aromatic hydrocarbons (specifically, benzene, toluene, and xylene, etc.), halogenated hydrocarbons (specifically, dichloromethane, dichloroethane, carbon tetrachloride, and chlorobenzene, etc.), ethers (specifically, dimethyl ether, diethyl ether, tetrahydrofuran, ethylene glycol dimethyl ether, and diethylene glycol dimethyl ether, etc.), ketones (specifically, acetone, methyl ethyl ketone, and cyclohexanone, etc.), esters (specifically, ethyl acetate and methyl acetate, etc.), dimethylformaldehyde, dimethylformamide, and dimethyl sulfoxide.

The coating liquid can be applied using any method capable of uniform coating, such as a dip coating, a spray coating, a spin coating, or a bar coating. The solvent may be removed by heating, pressure reduction, or a combination of heating and pressure reduction, specifically using a high-temperature dryer or a reduced-pressure dryer. The electrophotographic photosensitive member 1 can be manufactured as described above.

### <Effect of Electrophotographic Photosensitive Member>

Effects of the electrophotographic photosensitive member 1 will be described. The electrophotographic photosensitive member 1 functions as an image carrier in the image forming apparats such as a printer. Specifically, the surface of the electrophotographic photosensitive member 1 (hereinafter referred to as photosensitive member surface) is used in a state of positively charged in advance. When the photosensitive member surface is exposed by the exposure device, electrons generated in the photosensitive layer 3 are transported to the photosensitive member surface, causing the positive charges to decay. Consequently, an electrostatic latent image, which is an area where the charges decay, forms on the exposed area of the photosensitive member surface (hereinafter referred to as the exposed area). When the positively charged toner is supplied to the photosensitive member surface, the toner adheres to the electrostatic latent image, forming a toner image corresponding to the latent image. This toner image is then transferred to a matter to be printed, such as printing paper, to perform printing.

Here, the photoconductive layer 3 of the electrophotographic photosensitive member 1, having the aforementioned structure, possesses excellent electrical characteristics for such a printing process. Specifically, in the electrophotographic photosensitive member 1, a surface potential (VL) of the exposed area can be made small. If the surface potential (VL) is large, an amount of the toner adhering to the electrostatic latent image decreases, and an amount of the toner printed also decreases. However, by reducing the surface potential (VL), the amount of toner printed can be increased.

Furthermore, the electrophotographic photosensitive member 1 can minimize the amount of the change in the surface potential (ΔV0) during continuous printing. If the amount of the change (ΔV0) is large, the surface potential decreases during the printing, leading to the “fogging” where the toner adheres to areas outside the electrostatic latent image. Conversely, if the amount of the change (ΔV0) is small, the fogging can be prevented. Furthermore, the electrophotographic photosensitive member 1 can suppress the transfer memory potential. The transfer memory potential is a difference between a surface potential (V3) of unexposed areas (hereinafter referred to as non-exposed areas) and a surface potential (V4) of the unexposed area to which a transfer bias (2.5 kV) is applied. A large transfer memory potential causes uneven charging on the photosensitive member surface, whereas a small transfer memory potential prevents such uneven charging. As described above, the electrophotographic photosensitive member 1 enables the realization of excellent electrical characteristics.

### [Configuration of Image Forming Apparatus]

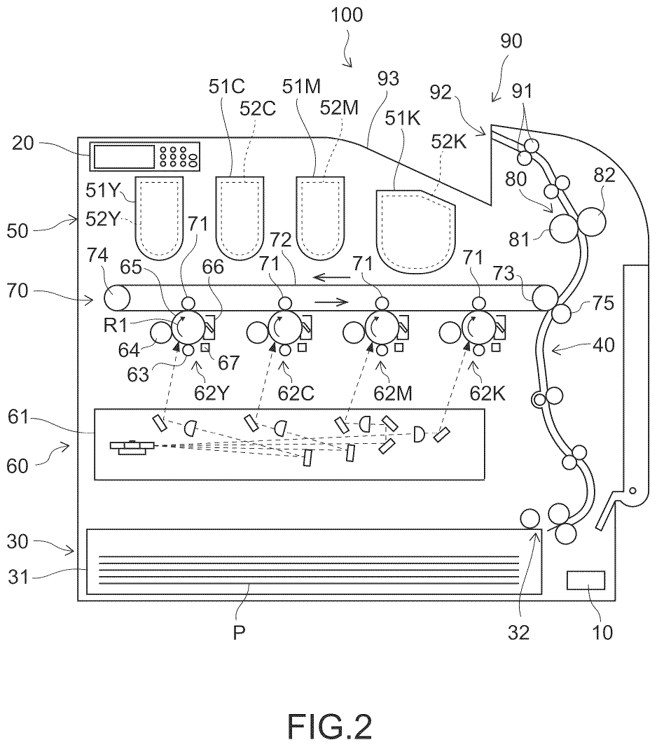

The image forming apparatus 100 according to an embodiment of the present disclosure will be described. FIG. 2 is a schematic diagram showing a configuration of the image forming apparatus 100. The image forming apparatus 100 is, for example, a tandem-type color printer.

As shown in FIG. 2, the image forming apparatus 100 includes a control unit 10, an operation unit 20, a paper feed unit 30, a transport unit 40, a toner supply unit 50, an image forming unit 60, a transfer device 70, a fixing device 80, and an ejection unit 90.

The control unit 10 controls an action of each part provided in the image forming apparatus 100. The control unit 10 includes a processing unit and a memory unit (not shown). The processing unit is, for example, a CPU (central processing unit), and the memory unit is, for example, a semiconductor memory or an HDD (hard disk drive). The processing unit controls an action of the image forming apparatus 100 by executing a control program. The memory unit stores the control program.

The operation unit 20 receives an instruction from a user. When the operation unit 20 receives the instruction from the user, it transmits a signal indicating the instruction of the user to the control unit 10. This initiates an image forming action by the image forming apparatus 100.

The paper feed unit 30 includes a paper feed cassette 31 and a paper feed roller group 32. The paper feed cassette 31 can hold several pieces of recording media P. The recording media P are, for example, printing paper. The paper feed roller group 32 feeds the recording media P held in the paper feed cassette 31 one by one to the transport unit 40.

The transport unit 40 includes rollers and guide members. The transport unit 40 extends from the paper feed unit 30 to the ejection unit 90. The transport unit 40 transports the recording medium P from the paper feed unit 30 to the ejection unit 90, passing through the image forming unit 60 and the fixing device 80.

The toner supply unit 50 supplies toner to the image forming unit 60. The toner supply unit 50 includes a first mounting portion 51Y, a second mounting portion 51C, a third mounting portion 51M, and a fourth mounting portion 51K. A first toner container 52Y is mounted on the first mounting portion 51Y. A second toner container 52C is mounted on the second mounting portion 51C, a third toner container 52M is mounted on the third mounting portion 51M, and a fourth toner container 52K is mounted on the fourth mounting portion 51K.

The first toner container 52Y holds yellow toner, and the second toner container 52C holds cyan toner. The third toner container 52M holds magenta toner, and the fourth toner container 52K holds black toner. Note that a color of the toner is not limited to be shown here and may be other colors. The number of colors may also be one or more.

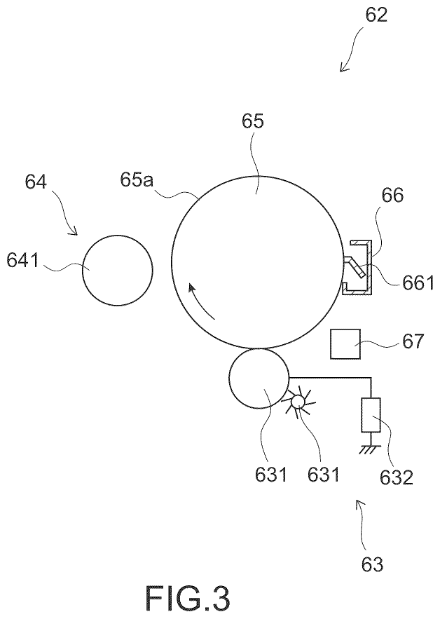

The image forming unit 60 includes an exposure device 61, a first image forming unit 62Y, a second image forming unit 62C, a third image forming unit 62M, and a fourth image forming unit 62K. FIG. 3 is a schematic diagram of the image forming unit 62. The first image forming unit 62Y, the second image forming unit 62C, the third image forming unit 62M, and the fourth image forming unit 62K each have a configuration of the image forming unit 62 shown in FIG. 3. The image forming unit 62 includes a charging device 63, a developing device 64, a photosensitive member 65, a cleaning device 66, and a static elimination device 67. The charging device 63, the developing device 64, the cleaning device 66, and the static elimination device 67 are arranged along a surface 65a of the photosensitive member 65.

The exposure device 61 (see FIG. 2) irradiates light (shown as dashed lines in FIG. 2) onto the surface 65a of the photosensitive member 65 provided in each image forming unit 62, thereby exposing the surface 65a. The exposure device 61 irradiates light for each color onto each image forming unit 62 based on supplied image data and performs exposure. The exposure device 61 can perform the exposure using laser light.

The photosensitive member 65 forms an electrostatic latent image when exposed by the exposure device 61. The photosensitive member 65 may be the electrophotographic photosensitive member 1 described above. The surface of the photosensitive layer 3 provided on the electrophotographic photosensitive member 1 is defined as the surface 65a of the photosensitive member 65. The surface 65a is positively charged in advance. When the surface 65a is exposed by the exposure device 61, the charges decay in the areas where light is irradiated, forming the electrostatic latent image. The photosensitive member 65 rotates in the direction (clockwise direction) indicated by the arrow shown in FIG. 3.

The charging device 63 positively charges the surface 65a. The charging device 63 includes a charging roller 631, a charging voltage power supply 632, and a cleaning brush 633. The charging roller 631 contacts the surface 65a to uniformly charge it. The charging voltage power supply 632 applies a charging voltage to the charging roller. This charging voltage is preferably a DC voltage. The cleaning brush 633 contacts the charging roller 631 and cleans the charging roller 631.

The developing device 64 feeds the toner supplied from the toner supply unit 50 to the surface 65a. As shown in FIG. 3, the developing device 64 includes a developing roller 641. The toner supplied from the toner container is mixed with a magnetic carrier to form a two-component developer. During this mixing, the toner becomes charged with the same polarity (positive) as the surface 65a due to friction with the carrier.

The two-component developer is attracted to the developing roller 641 by magnetic force and transported to a position facing the photosensitive member 65. A voltage is applied between the developing roller 641 and the photosensitive member 65, causing the toner in the two-component developer to adhere to the electrostatic latent image on the surface 65a. This forms the toner image on the surface 65a that corresponds to the electrostatic latent image.

The developing device 64 of the first image forming unit 62Y is connected to the first toner container 52Y, from which the yellow toner is supplied. Consequently, a yellow toner image is formed on the surface of the photosensitive member 65 included in the first image forming unit 62Y. Similarly, the developing device 64 included in the second image forming unit 62C is connected to the second toner container 52C, and a cyan toner image is formed on the surface of the photosensitive member 65 included in the second image forming unit 62C.

Furthermore, the developing device 64 included in the third image forming unit 62M is connected to the third toner container 52M, and a magenta toner image is formed on the surface of the photosensitive member 65 included in the third image forming unit 62M. The developing device 64 included in the fourth image forming unit 62K is connected to the fourth toner container 52K, and a black toner image is formed on the surface of the photosensitive member 65 included in the fourth image forming unit 62K.

The cleaning device 66 recovers the toner adhering to the surface 65a after transfer by the primary transfer roller 71 described later. Specifically, the cleaning device 66 includes a cleaning blade 661 and the static elimination device 67. The cleaning blade 661 is pressed against the surface 65a and cleans it by recovering the toner adhering to the surface 65a. The static elimination device 67 eliminates static electricity on the surface 65a by irradiating it with static elimination light.

The transfer device 70 (see FIG. 2) transfers the toner image from the photosensitive member 65 to the recording medium P, which is a transfer target. Specifically, the transfer device 70 transfers each color toner image formed on the surface 65a of the photosensitive member 65 included in each image forming unit 62, onto the recording medium P in a superimposed manner. The transfer device 70 can transfer each toner image onto the recording medium P in the superimposed manner using a secondary transfer method (intermediate transfer method). As a configuration for the secondary transfer method, the transfer device 70 includes four primary transfer rollers 71, an intermediate transfer belt 72, a drive roller 73, a follower roller 74, and a secondary transfer roller 75.

The intermediate transfer belt 72 is an endless belt stretched over the four primary transfer rollers 71, the drive roller 73, and the follower roller 74. The intermediate transfer belt 72 is driven in response to a rotation of the drive roller 73. In FIG. 2, the intermediate transfer belt 72 circulates in the direction indicated by the arrow in FIG. 2 (counterclockwise). The follower roller 74 is rotationally driven in response to the drive of the intermediate transfer belt 72.

Each image forming unit 62 faces an underside of the intermediate transfer belt 72 and is arranged in the order of the first image forming unit 62Y to the fourth image forming unit 62K, from an upstream side to a downstream side relative to a driving direction of the underside of the intermediate transfer belt 72.

Each primary transfer roller 71 is positioned facing each photosensitive member 65 via the intermediate transfer belt 72 and presses against each photosensitive member 65. Consequently, the toner image formed on the surface 65a of each photosensitive member 65 is sequentially transferred to the intermediate transfer belt 72 by each primary transfer roller 71. In the configuration of FIG. 2, the yellow toner image, the cyan toner image, the magenta toner image, and the black toner image are, in this order, transferred onto the intermediate transfer belt 72 in the superimposed manner, however, the order of the toner images is not limited to this. Hereinafter, the toner image formed by laminating the yellow toner image, the cyan toner image, the magenta toner image, and the black toner image is referred to as a “laminated toner image”.

The secondary transfer roller 75 is positioned facing the drive roller 73 via the intermediate transfer belt 72. The secondary transfer roller 75 is pressed against the drive roller 73. This creates a transfer nip (contact area) between the secondary transfer roller 75 and the drive roller 73. As the recording medium P passes through the transfer nip, the laminated toner image on the intermediate transfer belt 72 is transferred onto the recording medium P by the secondary transfer roller 75. A lamination order of the laminated toner image on the recording medium P is the reverse of a laminating order of the laminated toner image on the intermediate transfer belt 72. The recording medium P, with the laminated toner image transferred, is transported by the transport unit 40 toward the fixing device 80.

The fixing device 80 fixes the laminated toner image onto the recording medium P. The fixing device 80 includes a heating member 81 and a pressure member 82. The heating member 81 and the pressure member 82 are arranged facing each other, forming a fixing nip. The recording medium P transported from the image forming unit 60 is heated to a predetermined fixing temperature and pressed as it passes through the fixing nip, causing the laminated toner image to be fixed to the recording medium P. The recording medium P is transported by the transport unit 40 from the fixing device 80 toward the ejection unit 90.

The ejection unit 90 ejects the recording medium P with the laminated toner image fixed. The ejection unit 90 has a pair of ejection rollers 91, an ejection port 92, and an ejection tray 93. The pair of the ejection rollers 91 transports the recording medium P to the ejection tray 93 via the ejection port 92.

An image forming method by the image forming apparatus 100 will be described. When the control unit 10 acquires image data and the operation unit 20 receives a user instruction to start an image forming action, the photosensitive member 65 is rotated and driven in each image forming unit 62, and the charging roller 631 uniformly positively charges the surface 65a. Next, the exposure device 61 exposes the surface 65a of each image forming unit 62 according to the image data, forming the electrostatic latent image for each color on the surface 65a. Specifically, the electrons generated by the exposure are transported to the surface 65a, and the electrostatic latent image is formed as the electrons cause positive charging to decay.

The developing device 64 of each image forming unit supplies the toner of each color to the surface 65a, where it electrostatically adheres to the electrostatic latent image for that color. This forms the toner image of each color on the surface 65a of each photosensitive member 65. If an amount of the toner filled within each developing device 64 falls below a predetermined value due to toner image formation, the toner is supplied to each developing device 64 from the first toner container 52Y to the fourth toner container 52K.

An electric field is applied between the primary transfer roller 71 and the photosensitive member 65 at a predetermined transfer voltage by the primary transfer roller 71. This causes the toner image of each color on the surface 65a to be primarily transferred onto the intermediate transfer belt 72. The toner image of each color is laminated, forming the laminated toner image on the intermediate transfer belt 72. Subsequently, to prepare for the formation of a new electrostatic latent image, the toner and other residues remaining on the surface 65a after the primary transfer are removed by the cleaning device 66.

As the intermediate transfer belt 72 rotates in a counterclockwise direction by the rotation of the drive roller 73, the transport unit 40 transports the recording medium P to the transfer nip between the secondary transfer roller 75 and the drive roller 73 at a predetermined timing. The laminated toner image on the intermediate transfer belt 72 is then secondarily transferred onto the recording medium P. The recording medium P, with the laminated toner image secondary transferred, is transported by the transport unit 40 to the fixing device 80.

The recording medium P transported to the fixing device 80 is heated and pressed by the heating member 81 and the pressing member 82, causing the laminated toner image to be fixed to the surface of the recording medium P, thereby forming a color image on the recording medium P. The recording medium P with the formed color image is ejected to the ejection tray 93 at the ejection unit 90.

The image forming apparatus 100 has the above configuration. The configuration of the image forming apparatus according to the present disclosure is not limited to the above description, it may include the photosensitive member 65 having the configuration of the electrophotographic photosensitive member 1. For example, while the image forming apparatus 100 is described as capable of forming the color image, the image forming apparatus according to the present disclosure may also be an image forming apparatus capable of forming a monochrome image. In this case, the image forming apparatus need only be equipped with a single image forming unit.

Furthermore, although the developing device 64 is described as the two-component developing system supplying the two-component developer to the surface 65a, it may also be a one-component developing system supplying a one-component developer to the surface 65a. The one-component developer is a developer formed solely of the toner, without the toner being mixed with the carrier. Moreover, the developing device 64 may also be a rub roller system including a roller that rubs the surface 65a.

Furthermore, although the image forming apparatus 100 is described as a tandem type image forming apparatus, the image forming apparatus according to the present disclosure may be a rotary type image forming apparatus. Moreover, although the image forming apparatus 100 is described as a touchdown development type image forming apparatus, the image forming apparatus according to the present disclosure may be an image forming apparatus using a development method other than the touchdown development method.

Furthermore, although the image forming apparatus 100 is an intermediate transfer type image forming apparatus, the image forming apparatus according to the present disclosure may be a direct transfer type image forming apparatus. In this case, the toner image is directly transferred from the photosensitive member 65 to the recording medium P while the photosensitive member 65 is in contact with the recording medium P.

### [Configuration of Process Cartridge]

The process cartridge according to an embodiment of the present disclosure will be described. The process cartridge according to this embodiment corresponds to part or all of the image forming unit 62 described above (see FIG. 3) and includes at least the photosensitive member 65. Furthermore, the process cartridge according to this embodiment may include at least one of the charging device 63, the developing device 64, the cleaning device 66, and the static elimination device 67, in addition to the photosensitive member 65.

The process cartridge is configured to be attachable/detachable to/from the image forming apparatus 100. This allows the entire process cartridge to be easily replaced, for example, when sensitivity characteristics of the photosensitive member 65 deteriorate.

### Example

Each electrophotographic photosensitive member according to Examples of the present disclosure and Comparative Examples was prepared, and various physical property values were measured. Table 1 below shows configurations and measurement results of the electrophotographic photosensitive members according to Examples and Comparative Examples.

TABLE 1

| | Photo- | | Hole | Electron | | | | |
|---|---|---|---|---|---|---|---|---|
| | sensitive | Dispersion | transport | transport | Base | | | |
| | layer | aid | agent | agent | material | ΔV₀ (V) | V_{L} (V) | ΔV_{tc}(V) |
| Example 1 | A-1 | P-1 | H-1 | E-1 | Resin A | −14 | 131 | 6 |
| Example 2 | A-2 | | | | Resin B | −14 | 145 | 5 |
| Example 3 | A-3 | | | | Resin C | −13 | 135 | 6 |
| Example 4 | A-4 | | | | Resin D | −17 | 144 | 3 |
| Example 5 | A-5 | | | | Resin E | −11 | 156 | 5 |
| Example 6 | A-6 | | | | Resin F | −12 | 145 | 3 |
| Example 7 | A-7 | | | | Resin G | −14 | 155 | 2 |
| Example 8 | A-8 | | | | Resin H | −12 | 133 | 4 |
| Example 9 | A-9 | | | | Resin I | −15 | 139 | 3 |
| Example 10 | A-10 | | | | Resin J | −14 | 138 | 3 |
| Example 11 | A-13 | | | E-2 | Resin A | −15 | 156 | 4 |
| Example 12 | A-14 | | | E-3 | | −13 | 150 | 5 |
| Example 13 | A-15 | | | E-4 | | −15 | 154 | 3 |
| Example 14 | A-16 | | | E-5 | | −15 | 140 | 8 |
| Example 15 | A-17 | | | E-6 | | −14 | 155 | 5 |
| Example 16 | A-18 | | | E-7 | | −15 | 152 | 9 |
| Example 17 | A-19 | | | E-8 | | −15 | 141 | 6 |
| Example 18 | A-20 | | H-2 | E-1 | | −14 | 135 | 5 |
| Example 19 | A-21 | | H-3 | | | −14 | 138 | 3 |
| Example 20 | A-22 | | H-4 | | | −13 | 135 | 3 |
| Example 21 | A-23 | | H-5 | | | −23 | 140 | 4 |
| Example 22 | A-24 | P-2 | H-1 | E-1 | Resin C | −13 | 145 | 7 |
| Example 23 | B-17 | P-3 | | | | −42 | 159 | 43 |
| Comparative | B-1 | P-1 | H-6 | E-2 | Resin A | −33 | 115 | 32 |
| example 1 | | | | | | | | |
| Comparative | B-2 | | H-7 | | | −41 | 127 | 28 |
| example 2 | | | | | | | | |
| Comparative | B-3 | | H-8 | | | −49 | 105 | 60 |
| example 3 | | | | | | | | |
| Comparative | B-4 | | H-9 | | | −88 | 123 | 54 |
| example 4 | | | | | | | | |
| Comparative | B-9 | | H-1 | E-1 | Resin K | −85 | 128 | 43 |
| example 9 | | | | | | | | |
| Comparative | B-10 | | | | Resin L | −72 | 125 | 46 |
| example 10 | | | | | | | | |
| Comparative | B-11 | | | | Resin M | −69 | 130 | 39 |
| example 11 | | | | | | | | |
| Comparative | B-12 | | | | Resin N | −50 | 135 | 48 |
| example 12 | | | | | | | | |
| Comparative | B-13 | | | | Resin O | −88 | 145 | 57 |
| example 13 | | | | | | | | |
| Comparative | B-14 | | | | Resin P | −59 | 132 | 55 |
| example 14 | | | | | | | | |
| Comparative | B-15 | | | | Resin C | −55 | 180 | 88 |
| example 15 | | | | | | | | |

### <Preparation of Electrophotographic Photosensitive Member>

The electrophotographic photosensitive members according to Examples and Comparative Examples were prepared as follows:

First, a polyarylate resin serving as the base material for the photosensitive layer was prepared. Table 2 below shows a composition of each polyarylate resin. The notation such as (1-1) in Table 2 indicates the repeating unit of the formula (1-1), etc.

TABLE 2

| | Bisphenol content | | | | Dicarboxylic acid | | | | | |
|---|---|---|---|---|---|---|---|---|---|---|
| | ratio [%] | | | | content ratio [%] | | | | | |
| Monomer | BisCZ | BisB | BisZ | BP | 14NACC | 26NACC | DCDE | TPC/IPC | Terminal | |
| Formation | Unit | Unit | Unit | Unit | Unit | Unit | Unit | Unit | stopping | Molecular |
| unit | (1-1) | (1-2) | (1-3) | (3) | (4) | (2-1) | (2-2) | (TPC/IPC) | agent | weight |
| Resin A | 95 | — | — | 5 | 50 | 50 | — | — | DMP | 55400 |
| Resin B | — | 95 | — | 5 | 50 | 50 | — | — | DMP | 64200 |
| Resin C | 90 | — | — | 10 | 50 | 50 | — | — | DMP | 54500 |
| Resin D | 81 | — | — | 19 | 50 | 50 | — | — | DMP | 52700 |
| Resin E | — | 81 | — | 19 | 50 | 50 | — | — | DMP | 62300 |
| Resin F | 95 | — | — | 5 | 35 | 65 | — | — | DMP | 58000 |
| Resin G | 95 | — | — | 5 | 65 | 35 | — | — | DMP | 54300 |
| Resin H | 95 | — | — | 5 | 50 | 50 | — | — | PFH | 56800 |
| Resin I | 95 | — | — | 5 | 50 | — | 50 | — | DMP | 58500 |
| Resin J | 95 | — | — | 5 | 35 | — | 65 | — | DMP | 58900 |
| Resin K | 100 | — | — | — | 50 | 50 | — | — | DMP | 55900 |
| Resin L | 95 | — | — | 5 | — | — | — | 50/50 | DMP | 50200 |
| Resin M | 100 | — | — | — | — | 50 | 50 | — | DMP | 57300 |

| | | | |
|---|---|---|---|
| Resin N | See formula (S-1) | DMP | 55300 |
| Resin O | See formula (S-2) | DMP | 54100 |
| Resin P | See formula (S-3) | DMP | 53000 |

In Table 2, “Resin A” to “Resin J” satisfy the base material described in the above Embodiments. Specifically, “Resin A” to “Resin J” are polyarylate resins including the repeating units represented by the formula (1), the formula (2), the formula (3), and the formula (4), and the content ratio of the repeating unit represented by formula (3) with respect to the total number of the repeating units represented by the formula (1) and the formula (3) is greater than 000 and less than 20%.

For example, “Resin A” is formed by condensation polymerization of bisphenol containing bisphenol CZ (content ratio 95%) and BP (content ratio 5%) with dicarboxylic acid containing 14NACC (content ratio 50%) and 26NACC (oil content ratio 50%), and is a polyarylate resin having a content ratio of 95% of the repeating unit of the formula (1-1), a content ratio of 5% of the repeating unit of the formula (3), a content ratio of 50% of the repeating unit of the formula (2-1), and a content ratio of 50% of the repeating unit of the formula (4). Therefore, in “Resin A,” the content ratio of the repeating unit represented by the formula (3) with respect to the total number of repeating units represented by the formula (1) and the formula (3) is 5%. Similarly, for “Resin B” through “Resin J”, the content ratio of the repeating unit represented by the formula (3) with respect to the total number of repeating units represented by formula (1) and formula (3) is greater than 0% but less than 20%.

On the other hand, “Resin K” through “Resin P” are resins that do not satisfy the base material described in the above embodiments. Specifically, “Resin K” does not contain the repeating unit of the formula (3), and “Resin L” does not contain the repeating units of the formulas (2) and (4). Instead, “Resin L” uses TPC (terephthalic acid) represented by the following formula (C-1) and IPC (isophthalic acid) represented by the following formula (C-2) as dicarboxylic acids. “Resin M” also does not contain the repeating units of the formula (3).

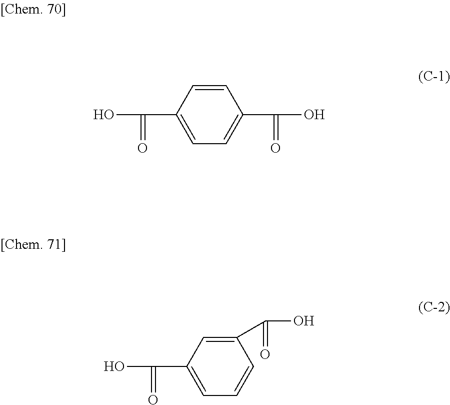

“Resin N” has a structure represented by the following formula (S-1), and “Resin O” has a structure represented by the following formula (S-2). “Resin P” has a structure represented by the following formula (S-3).

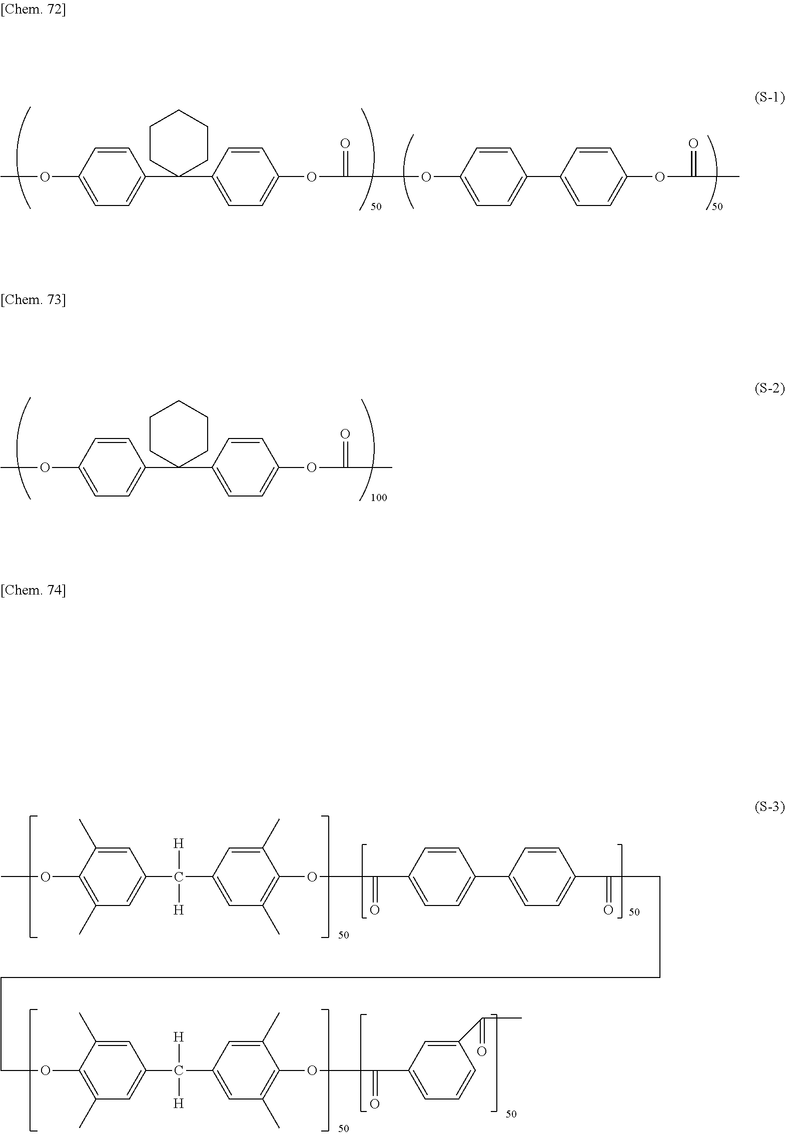

Next, 100 parts of the base material, 2 parts of the charge generation material, 1.3 parts of the dispersing aid, 70 parts of the hole transport agent, and 50 parts of the electron transport agent were dispersed in 500 parts of a solvent (tetrahydrofuran). The charge generation material was Y-type titanyl phthalocyanine, and the other materials were those shown in Table 1. For example, in Example 1, 100 parts of the resin A, 2 parts of Y-type titanyl phthalocyanine, 1.3 parts of the dispersing aid represented by the formula (P-1), 70 parts of the hole transport agent represented by the formula (H-1), and 50 parts of the electron transport agent represented by the formula (E-1) were dispersed in 500 parts of a solvent (tetrahydrofuran).

Dispersion was performed using a rod-shaped ultrasonic oscillator for 20 minutes. The prepared liquid was filtered using a 5 μm mesh filter to produce a coating solution. This coating solution was applied to a conductive base by dip coating, dried at 120° C. for 50 minutes, and a photosensitive layer was formed. A thickness of the photosensitive layer was 30 μm.

Note that “H-6” to “H-9” in Table 1 are the hole transport agents represented by the following formulae (H-6) to (H-9), and are not included in the hole transport agents (hole transport agents represented by the formula (7) or the formula (8)) according to the above embodiments.

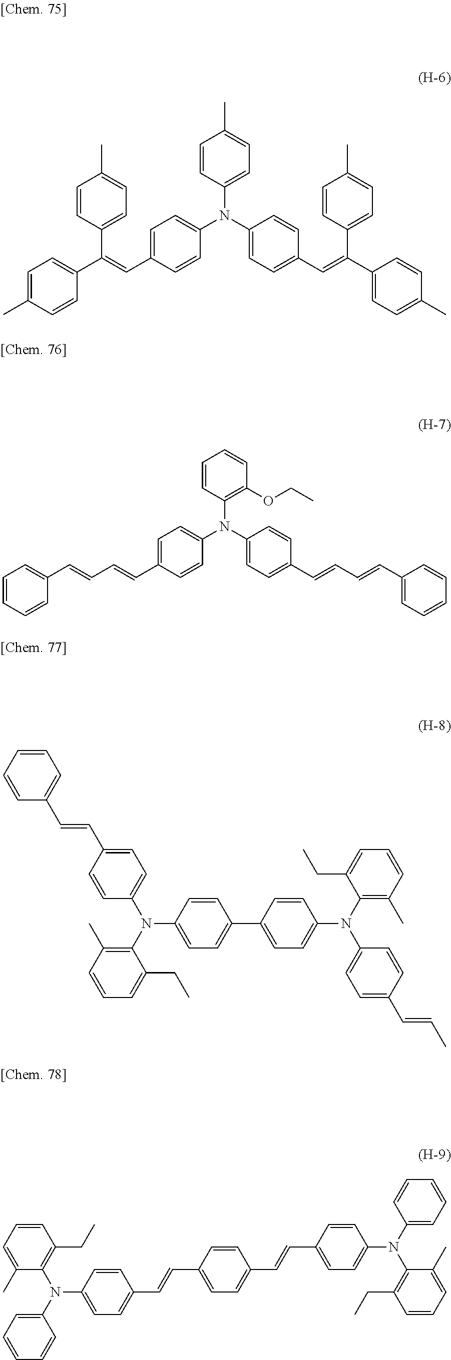

A differences between Comparative examples and Examples are as follows: each electrophotographic photosensitive member of Comparative Examples 1 to 4 use the hole transport agents (H-6 to H-9) in the photosensitive layer that are not the hole transport agents of the above embodiments; each electrophotographic photosensitive member of Comparative Examples 9 to 14 use the polyarylate resins (Resin K to Resin P) as the base material of the photosensitive layer that are not the polyarylate resins of the above embodiments. Furthermore, the electrophotographic photosensitive member according to Comparative Example 15 does not contain the dispersing aid in the photosensitive layer. On the other hand, the electrophotographic photosensitive members of Examples 1 to 23 have the configuration described in the above embodiments.

The electrophotographic photosensitive members according to Examples and Comparative Examples prepared as described above were mounted in an evaluation machine, and printing and various measurements were performed. The evaluation machine was a printer “TASKalfa MA4500ci” (manufactured by Kyocera Document Solutions Inc.), which employs an intermediate transfer method. The evaluation machine is equipped with a charging roller configured of a charging rubber (epichlorohydrin resin with dispersed conductive carbon). A charging polarity of the electrophotographic photosensitive member was set to positive, and an applied voltage was a DC voltage.

For the electrophotographic photosensitive member mounted in the evaluation machine, a charging potential of the photosensitive member was set to 470±30V in an environment of 23° C. and 50% humidity, and exposure was performed on the photosensitive member surface. The exposure conditions were a wavelength of 780 nm, a half-width of 20 nm, and a light intensity of 0.8 μJ/m².

After the exposure, a post-exposure potential V, a surface potential V3 of an unexposed area, and a surface potential V4 of the unexposed area after applying a transfer bias (2.5 kV) were measured. The exposed area is where the toner adheres, while the unexposed area is where the toner does not adhere (white paper area). The post-exposure potential V is a potential measured at a development position using a surface probe after the exposure.

The amount of the change ΔV0 in the surface potential was calculated from the initial potential V0 (470V) and the potential V after the exposure using the following equation: ΔV0=V0−V

Furthermore, a transfer memory potential ΔVtc was calculated from the surface potential V3 of the unexposed area and the surface potential V4 of the unexposed area with the transfer bias applied, using the following equation: ΔVtc=V3−V4

The surface potential VL of the exposed area, the amount of the change in the surface potential ΔV0, and the transfer memory potential ΔVtc are shown in Table 1. As shown in Table 1, each electrophotographic photosensitive member of Examples 1 to 23 had the amount of the change in the surface potential change ΔV0 close to zero, while those of Comparative Examples 1 to 15 had a larger ΔV0. Therefore, the electrophotographic photosensitive members of Examples 1 to 23 exhibit a small change in the surface potential during the printing, making them less prone to the “fogging” where the toner adheres to areas other than the electrostatic latent image.

Furthermore, the electrophotographic photosensitive members of Examples 1 to 23 had a smaller transfer memory potential ΔVtc, whereas the electrophotographic photosensitive members of Comparative Examples 1 to 15 had a larger transfer memory potential ΔVtc. Therefore, it can be said that the electrophotographic photosensitive members of Examples 1 to 23 can prevent printing errors caused by charging irregularities.

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photosensitive member, comprising:
a conductive base; and
a photosensitive layer provided on the conductive base, wherein the photosensitive layer contains a base material, a charge generation material, a dispersing aid, a hole transport agent, and an electron transport agent,
wherein the base material is a polyarylate resin having repeating units represented by the following formula (1), formula (2), formula (3), and formula (4), in which a content ratio of the repeating units represented by the formula (3) with respect to a total number of the repeating units represented by the formula (1) and formula (3) is greater than 0% and less than 20%,
wherein the charge generation material is titanyl phthalocyanine,
wherein the dispersion aid includes a compound represented by the following formula (5) or formula (6),
wherein the hole transport agent includes a compound represented by the following formula (7) or formula (8) 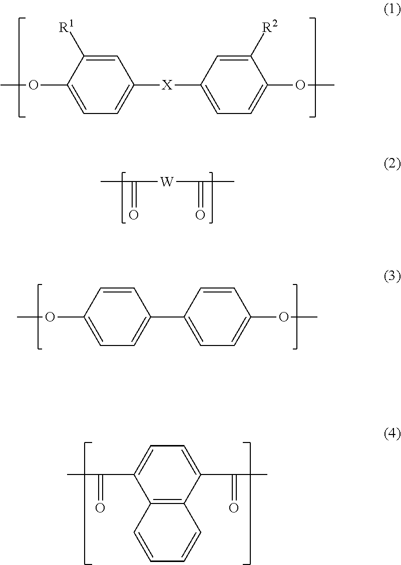
in the formula (1), R¹ and R² each independently represents a hydrogen atom or a methyl group, and X represents a divalent group represented by the following formula (X1) or formula (X2), in the formula (2), W represents a divalent group represented by the following formula (W1) or formula (W2), 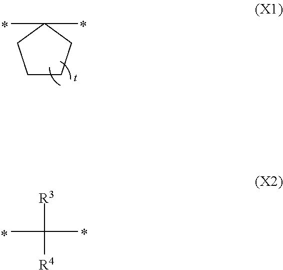
in the formula (X1), t represents an integer of 1 or more and 3 or less, * represents a bond, in the formula (X2), R³ and R⁴ each represents a hydrogen atom or an alkyl group having 1 or more and 4 or less carbon atoms, which are mutually different groups, * represents a bond, 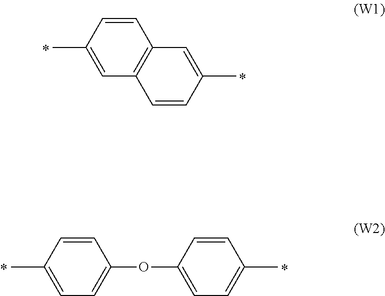
in the formula (W1) and the formula (W2), * represents a bond, 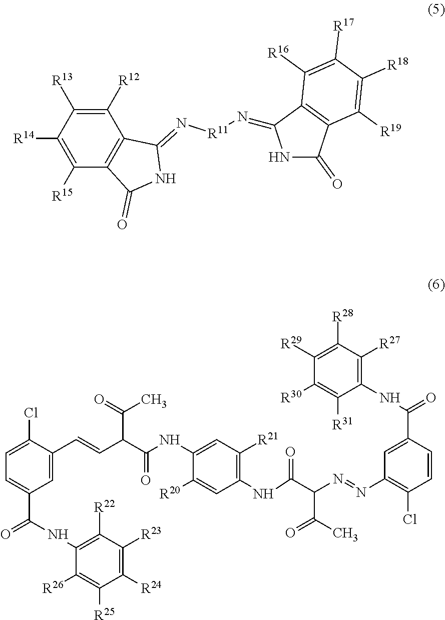
in the formula (5), R¹¹ represents a phenylene group which may be substituted by an alkyl group, or a biphenyldiyl group which may be substituted by an alkyl group, R¹², R¹³, R¹⁴, R¹⁵, R¹⁶, R¹⁷, R¹⁸, and R¹⁹ each independently represents a hydrogen atom or a halogen atom, and in the formula (6), R²⁰ and R²¹ each independently represents a hydrogen atom or a halogen atom, and R²², R²³, R²⁴, R²⁵, R²⁶, R²⁷, R²⁸, R²⁹, R³⁰, and R³¹ each independently represents a hydrogen atom, a halogen atom, a trifluoromethyl group, or a phenoxy group, 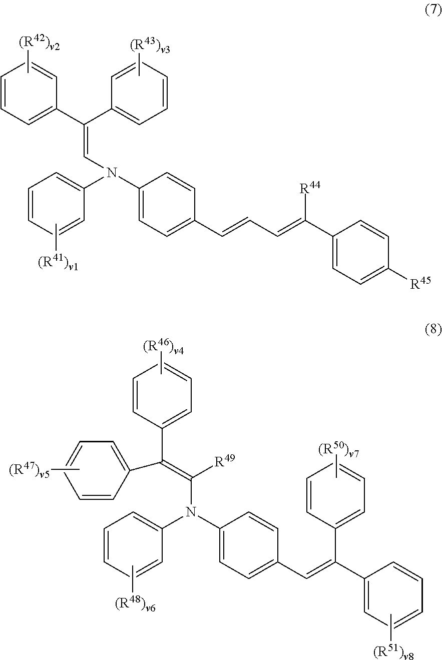
in the formula (7) and the formula (8), R⁴¹ represents an alkyl group having 1 to 8 carbon atoms or an alkoxy group having 1 to 8 carbon atoms, R⁴², R⁴³, R⁴⁶, R⁴⁷, R⁴⁸, R⁵⁰, and R⁵¹ each independently represents an alkyl group having 1 to 8 carbon atoms, R⁴⁴ represents an aryl group or a hydrogen atom, R⁴⁵ and R⁴⁹ each represents an alkyl group having 1 to 8 carbon atoms or a hydrogen atom, and v1, v2, v3, v4, v5, v6, v7, and v8 each independently represents an integer of 0 to 5.

2. The electrophotographic photosensitive member according to claim 1, wherein the electron transport agent is a compound represented by the following formula (9), formula (10), formula (11), formula (12), formula (13), formula (14), or formula (15) 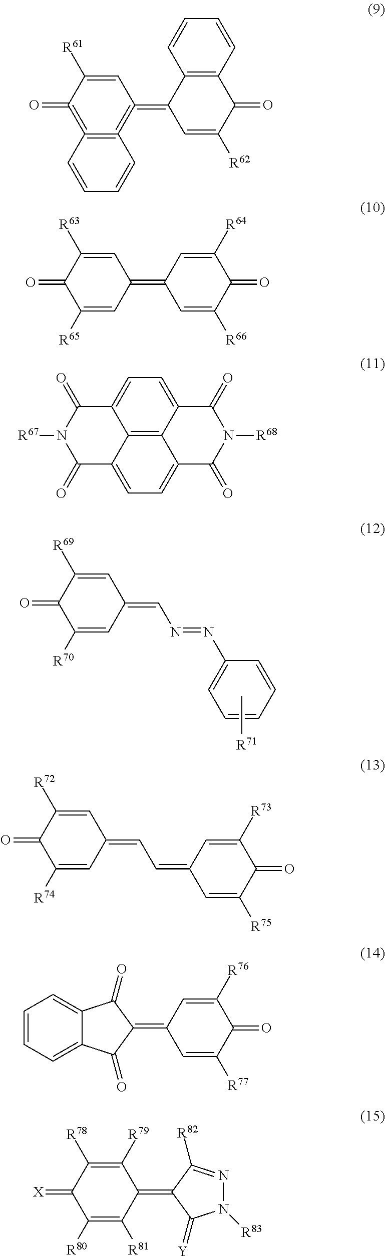
in the formula (9), the formula (10), the formula (11), the formula (12), the formula (13), the formula (14), and the formula (15), R⁶¹, R⁶², R⁶³, R⁶⁴, R⁶⁵, R⁶⁶, R⁶⁷, R⁶⁸, R⁶⁹, R⁷⁰, R⁷¹, R⁷², R⁷³, R⁷⁴, R⁷⁵, R⁷⁶, R⁷⁷, R⁷⁸, R⁷⁹, R⁸⁰, R⁸¹, R⁸², and R⁸³ are each independently represents a hydrogen atom, a halogen atom, a cyano group, an alkyl group having 1 to 6 carbon atoms, an alkenyl group having 2 to 6 carbon atoms, an alkoxy group having 1 to 6 carbon atoms, an allyl group having 6 to 14 carbon atoms which may have at least one alkyl group having 1 to 6 carbon atoms, or a halogenated aryl group having 6 to 14 carbon atoms which may have at least one alkyl group having 1 to 6 carbon atoms.

3. A process cartridge, comprising the electrophotographic photosensitive member according to claim 1.

4. An image forming apparatus, comprising:
the electrophotographic photosensitive member according to claim 1;
a charging device that charges a surface of the electrophotographic photosensitive member;
an exposure device that exposes the charged surface to form an electrostatic latent image on the surface;
a developing device that develops the electrostatic latent image into a toner image; and
a transfer device that transfers the toner image from the electrophotographic photosensitive member to a transfer target.

5. The image forming apparatus according to claim 4, wherein the charging device includes a charging roller.

6. The image forming apparatus according to claim 4, wherein the developing device is a two-component developing system.
